(19) United States
(12) Patent Application Publication
(10) Pub. No.: US 2004/0191382 A1
(43) Pub. Date: Sep. 30, 2004

(54) Ultra-high-pressure vegetable sterilization method and product

(76) Inventors: Kern L. Cooper, Idaho Falls, ID (US); Mark K. Call, Blackfoot, ID (US); Richard S. Meyer, Tacoma, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/722,384

(22) Filed: Nov. 25, 2003

Related U.S. Application Data
(60) Provisional application No. 60/459,066, filed on Mar. 27, 2003.

(51) Int. Cl. A23L 3/16

(52) U.S. Cl. 426/521

(57) ABSTRACT

Vegetables, specifically potatoes, are sterilized using ultra-high-pressure processing. The freshly cooked flavor of the vegetables is retained by preprocessing the vegetables by partially cooking quickly and thereafter subjecting to ultra-high-pressure sterilization.

### CROSS-REFERENCE TO RELATED APPLICATION

This application claims the benefit of U.S. Provisional Application No. 60/459,066, filed Mar. 27, 2003.

### BACKGROUND OF THE INVENTION

This invention relates to methods for commercially sterilizing foods having pH of at least 4.5 using ultra-high pressure.

Researchers have suggested foods can be sterilized using ultra-high pressures and high temperatures using an instantaneous temperature change that uses ultra-high pressure (“UHP”) to produce an instantaneous high temperature. This is stated to deliver a fast and therefore gentle thermal process to a pre-packaged product. See U.S. Pat. No. 6,086,936 ('936 patent). This patent discloses a single application (pulse) of pressure.

An improved process for ultra-high-pressure, high-temperature food preservation is set forth in U.S. Pat. No. 6,177,115 ('115 patent). In the background of the '115 patent at column 1, line 62, to column 2, line 22, some of the deficiencies of the single pulse pressure method are set forth with respect to PCT Application No. WO97/21361 (corresponding to the '936 patent). The '115 patent provides significantly improved sterility by the use of two pulses of pressure. Specifically, it discloses the application of high pressure, followed by a brief pressure reduction and a second application of high pressure. The '115 patent discloses sterilization of a number of food products, including mashed potatoes.

### SUMMARY OF THE INVENTION

It is an object of the invention to provide a method for producing an at least partially cooked mashed vegetable, in particular potatoes or beans, which is packaged and sterilized and has a flavor substantially unchanged after high-pressure sterilization.

It is a further object of the invention to provide a method for producing a partially cooked vegetable which is packaged and sterilized using high pressure having a substantially freshly cooked flavor that can be cut into pieces and fried or grilled or baked by the end user.

One embodiment of the invention is a method for making a shelf-stable product comprising a mashed vegetable. The method comprises the steps of (a) at least partially cooking a vegetable (e.g., potatoes or beans) having a pH of at least 4.5, (b) mashing the vegetable of step (a), (c) packaging the mashed vegetable of step (b) in a sealed container, (d) optionally mixing flavoring ingredients with the vegetable prior to step (c), (e) sterilizing said packaged vegetable by pressurizing comprising subjecting said packaged vegetable to an initial pressurizing temperature of at least about 60° C. to a first pressure of at least about 50,000 psi to heat the vegetable to a temperature in excess of about 90° C., and (f) releasing the pressure. The vegetable is not subjected to an elevated temperature for a time greater than about 120 minutes after mashing in step (b) and prior to sterilization in step (e).

Another embodiment of the invention is a method for making a shelf-stable product comprising a partially cooked vegetable. The method comprises the steps of (a) packaging a partially cooked vegetable at a temperature in excess of 60° C. in a sealed container, (b) sterilizing said packaged partially cooked vegetable by pressurizing comprising subjecting said packaged vegetable to an initial pressurizing temperature of at least about 60° C. to a first pressure of at least 50,000 psi to heat the vegetable to a temperature in excess of about 100° C., and (c) releasing said pressure. The packaged vegetable is pressurized at said initial temperature within about 40 minutes of packaging.

In another embodiment, step (a) of the method of the preceding paragraph is performed by packaging a partially cooked whole potato or potato piece, said whole potato or potato piece having been cooked but the degree of gelatinization being less than 80%.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1-3 are simplified flow diagrams of processes according to the present invention.

### DETAILED DESCRIPTION OF THE PREFERRED EMBODIMENT

The present invention is directed to vegetables which have been sterilized by the combination of high temperature and ultra-high pressure. Used herein, the term “vegetable” includes potatoes, beans, avocados, broccoli, corn, squash, peas, carrots, radishes, rutabaga, asparagus, beets, string beans, other legumes, grains such as corn, wheat, and rice, sweet potatoes, yams, cauliflower, cabbage, kohlrabi, okra, spinach, garlic, onions, peppers, tomatoes, parsley, parsnips, turnips, cucumbers, plant sprouts, celery, bok choy, collards, Brussels sprouts, egg plants, squash, pumpkins, fennel, kale, pomegranate, leeks, lettuce, mushrooms, olives, rhubarb, chives, coconut, and the like. The vegetable is packaged and sterilized. The vegetable can be packaged with the vegetable alone or with other ingredients such as flavoring ingredients. If the vegetable is mixed with flavoring ingredients, the description will refer to the vegetable component of the packaged product. The vegetable is defined as having a pH of at least 4.5. For simplicity of description, the present description will refer to potatoes as the vegetable, but the invention is understood to encompass the other vegetables, such as beans.

1. Mashed Vegetable (Potatoes)

The invention will first be described with respect to making a mashed vegetable product which is at least partially cooked, mashed, and packaged with optional mixing of flavor ingredients followed by sterilization.

The processes described herein are suitable for use with commercial quantities of potatoes. In such instances, the packaging could be in bags with capacities on the order of 150 to 4000 ml with a quantity of potatoes per bag of at least 100 grams, more preferably 450 grams, at least 1600 grams, and most preferably at least about 3250 grams, depending on the desired use.

An important aspect of the present invention is to limit the time of exposure of the potatoes to high temperature prior to sterilization. Potatoes are heat sensitive and such pre-sterilizing control reduces damage to the flavor and texture prior to pressure treatment.

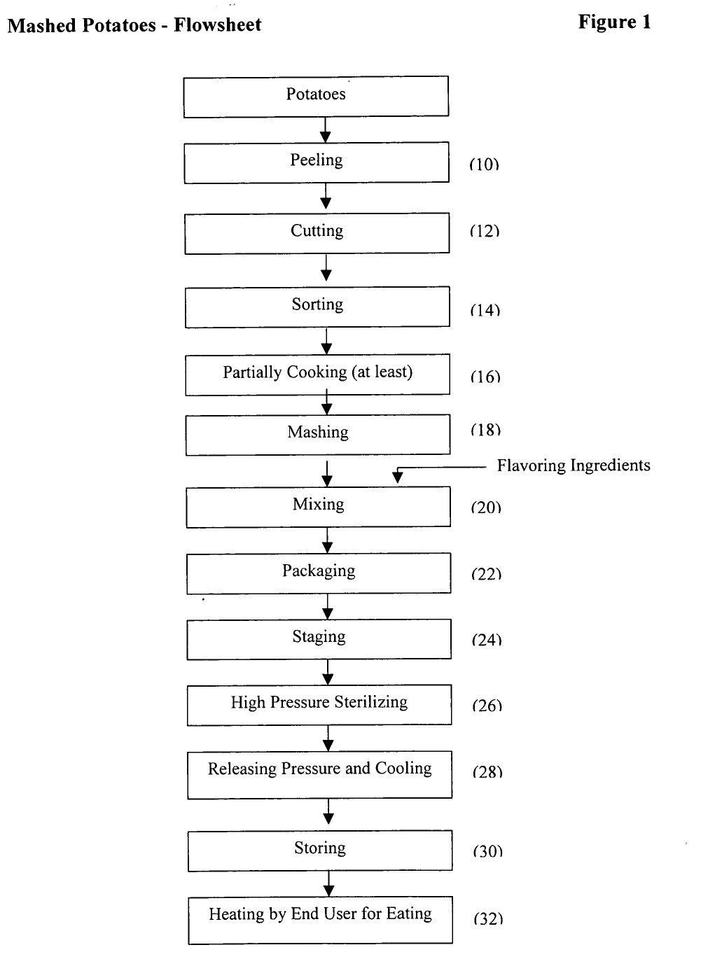

FIG. 1 illustrates a simplified flow diagram for making a shelf-stable mashed potato using ultra-high pressure.

Referring to Step 10, potatoes, typically less than 2.5 inches in diameter, optionally are peeled by conventional techniques such as described in Chapter 9 of Talburt, W. F. and Smith, O., Potato Processing, 4th Edition (“Potato Processing”) at page 333. Potatoes conventionally used for mashed potatoes can be used in this process. Such potatoes include: russet Burbank, russet norkotah, shepody, alturas, Cal. white, Idaho russet, and norgold.

In Step 12, the potato optionally can be cut or sliced to a desired size, such as 1.25 inch to 1.5 inch pieces or 0.125″ to 0.75″ slabs, using conventional techniques. The purpose of cutting the potatoes is to provide a sized potato suitable for heating the interior of the potato to the desired temperature in a short time.

After cutting, the potatoes may be sorted in Step 14. The sorting is for the purpose of eliminating undesirable blemishes and defects, and can be accomplished by methods conventionally used for making dehydrated potatoes such as granules and slices.

In Step 16, the potatoes are heated to the desired temperature to at least partially cook the potato. The “at least partially cooking” Step 16 is intended to encompass partial to complete cooking of the potato as the term is used in the potato industry. Unless otherwise specified, the terms “at least partial cooking” and “cooking” are used interchangeably herein. Preferably the at least partial cooking is performed to heat the interior of the potato to at least about 65° C., preferably to at least about 85° C., more preferably to at least about 90° C. Preferably, the time to reach cooking temperature is less than about 90 minutes, and more preferably less than 45 minutes, and most preferably 30 minutes or less. Preferably, the potato is not fully cooked although it can be fully cooked if desired. Care should be taken to avoid overcooking of the potato in Step 16. Overcooking is characterized by swelling of the potato starch cells to the point of disintegration preceded by the collapse of the swollen cells.

One measure of the amount of cooking of Step 16 is the degree of gelatinization in this step. It is preferable that the percent gelatinization of the starch be at least about 80%, preferably at least about 85%, and most preferably greater than about 90% as measured by a differential scanning colorimeter (“DSC”) technique. Additional gelatinization can occur during subsequent processing steps associated with the sterilization process. Another test of the degree of cooking is by analyzing the texture using a TA-XT2 Texture Analyzer (TA Instruments Corp., New Castle, Del.) with P/2N Needle Probe. Such testing is performed as follows: 1 cc cubes are cut from cooked potatoes immediately after cooking and placed on a platform positioned centrally under the 2 mm needle probe that is attached to the load cell carrier. The test begins and measures the force to penetrate the center of the potato. Replicates of each cooking condition are made to assure consistency.

The time for at least partial cooking in Step 16 can vary. Typically, cooking is performed in steam or hot water as is conventional for the cooking of potatoes for producing dehydrated products such as granules or flakes. Depending on the desired temperature after cooking, time may be less than about 90 minutes, preferably less than about 45 minutes, and most preferably less than 30 minutes. An advantage of a shorter cooking time is to provide a flavor and texture to the end product substantially the same as from scratch, that is, a mashed potato product from fresh potatoes that are cooked, mashed, and served while still warm.

As used herein, the term “at least partially cooking” in Step 16 also encompasses multiple steps that achieve an at least partially cooked potato. For example, the potato may be precooked, cooled, and cooked, a process that is known in the making of flakes or granules. Such a precooked, cooled, and cooked process is described in chapter 13 of Talbert, W. F. & Smith, O., Potato Processing, 4^{th} edition at page 569.

After Step 16, the potato pieces are mashed (e.g., by ricing) in Step 18 in a manner conventionally used for mashing potatoes which is in a process for producing granules or flakes, e.g., Potato Processing at page 575. Mashing refers to comminuting the potatoes to a continuous mass of a consistency and particle size comparable to a conventional mashed potato made from scratch. Typical conditions are to force the potato through a ricer with a grid with openings of 0.375 inch for discharge.

In Step 20, the mashed potato is typically mixed with a variety of flavoring ingredients. Such ingredients are well known in the field and typically include flavoring ingredients added to fresh mashed potatoes to produce an end product including milk, butter, salt, and the like. Any of the well-known methods may be used to mix flavoring ingredients into the mashed potato. One way is to add the flavoring ingredients to the mashed potato in a hot water jacketed paddle mixer maintained under a steam environment.

As will be discussed in more detail later, it is preferable to maintain the temperature (from mashing to mixing to sterilizing described below) so that the potato is not cooled below about 30° C. during these steps. Thus, potatoes preferably are maintained during these steps at a temperature in excess of about 60° C., more preferably 75° C., and most preferably 90° C. It is preferred that the temperature decrease no more than about 30° C., preferably 15° C., more preferably 5° C. or less below the temperature of mashing or other preprocessing and prior to pressurizing during sterilization to be described hereinafter. This temperature profile from mashing to sterilization is referred to as “the temperature maintenance range.” It provides the following benefits: 1) provides temperature continuity between the mashing step and the sterilization step, 2) provides additional gelatinization, and 3) maintains the fresh flavor of the partially cooked food while allowing the adiabatic temperature increase during pressurization to sterilize the food.

In Step 22, the mashed potatoes, normally including flavoring ingredients, are packaged or packed into packages, preferably flexible bags acceptable for UHP processing described hereinafter and for long-term storage at room temperature or refrigerated. Suitable packages should have at least one dimension with a flexible surface and are preferably of the nonmetal type, particularly not formed of a rigid metal. The potatoes are preferably hermetically packaged anaerobically, typically either under vacuum or in an inert gas atmosphere. It is preferable to package at a temperature within the temperature maintenance range. Suitably, heating or maintenance of the temperature range prior to packaging is performed in a steam-jacketed/steam-blanketed filling operation. By packaging under such conditions and hermetically sealing, an anaerobic atmosphere is created.

After packaging, it takes some time to move the packages from the packaging area to the UHP equipment for performing high-pressure sterilization. Such time will be referred to herein as staging in Step 24. It is preferable that the time for staging be limited. Further, as with Steps 20 and 22, it is preferable that the temperature for staging be within the temperature maintenance range. In one form of staging, the packages are moved from the steam environment in Step 22 into a microwave tunnel 3 Kw for preheating (3 Kw at 915 MHz), which enables preheating from 25° C. to 95° C. in 90 to 120 seconds. Other heating apparatus such as induction heaters or a heated water bath may also be used.

It is important to limit the exposure of the mashed potato to an elevated temperature during the pre-pressurizing steps. One measure of this exposure is by reference to the time of exposure to high temperature in this interval. Suitably, the mashed potato product is not subject to an elevated temperature or a time greater than about 60 minutes after mashing in Step 18 and prior to sterilization in Step 26. Preferably, it is not subject to elevated temperature for greater than about 25 minutes, more preferably for a time not greater than about 15 minutes, 13 minutes, 11 minutes, or most preferably fewer than 9 minutes. The time is dependent on the temperature maintenance range.

It is preferable that the temperature from mashing in Step 18 to pressurizing be greater than a certain minimum temperature for achieving commercial sterilization. Suitably, that temperature is at least at 60° C., or preferably 75° C., 80° C., 85° C., or 90° C. It is currently believed that the temperature should be at least 85° C. for most effective commercial sterilization in Step 26. However, the temperature should not be so high as to cause an overcooked flavor for the mashed potato. Thus, it is preferable that the pre-processing temperature not be in excess of 90 to 99° C.

In Step 26, the mashed potatoes are subject to UHP. One suitable form of high-pressure sterilization is described in the '115 patent. This patent describes a multiple-pulse pressure process. That is, the potatoes first are pressurized, the pressure is released, and then pressurized at least one more time prior to releasing of the pressure, cooling and reheating by the end user for eating. The initial temperature for pressurizing for the potato in the package is at least about 60° C. with a pressure of at least about at 50,000 psi applied to heat the potato adiabatically to a temperature in excess of about 100° C. Preferably the initial temperature is at least about 75° C., 80° C., 85° C., or 90° C. The initial temperature is dependent upon the pressure applied. The pressure for the first pulse is suitably at least 50,000 psi, 60,000 psi, 70,000 psi, 80,000 psi, 90,000 psi, 100,000 psi, 110,000 psi, 120,000 psi, 130,000 psi, 140,000 psi, 150,000 psi, or more. The pressure for the second pulse can be lower than for the first pulse. Higher pressures permit the use of lower temperatures but can lead to more expensive processing. However, the initial temperature and pressure are also dependent on whether multiple pulses are used or a single pulse. Initially the sterilizing conditions will be described with respect to the multi-pulse application as described in the '115 patent.

The application of pressure causes an adiabatic temperature rise. Typically, the adiabatic temperature rise, depending upon the pressure applied, is at least 15° C., up to 30° C., 60° C. or more. The magnitude of the adiabatic temperature increase is a function of the pressure of application and the initial temperature. The temperature increase follows a decrease in the volume of the food and associated water. For example, water at an initial temperature of 80° C. will decrease in volume over 15% with a corresponding increase in temperature of greater than 30° C. when subjected to a pressure of 100,000 psi.

The total time in the UHP vessel is preferably less than about 20 minutes to avoid overcooked flavor and texture to the end product. Full pressurization can be accomplished in a relatively short period of time on the order of less than 1 to about 2 minutes. The total time in the pressurized vessel is preferably less than about 20 minutes, more preferably 15 minutes, 10 minutes, 7 minutes, and most preferably less than 5 minutes. This applies whether a single pulse or a double pulse is used. If a double pulse is used, the pressurizing time for the first pulse may be on the order of less than 30 seconds to about 2 minutes, with a release of the pressure in about 10 seconds to 30 seconds or more, followed by a repressurizing time of less than 30 seconds to about 2 minutes. Suitable pressurizing conditions to provide commercial sterilization are defined in the '115 patent, the same definition used herein.

As set forth above, the high-pressure sterilizing Step 26 may also be accomplished in a single pressuring step or a multiple-pulse pressurizing. As used herein, the term “pressurizing” refers to the initial pressurizing as the first of multiple pulses of pressure, or if a single pressure is applied, refers to only a single application of pressure. It is believed that commercial sterilization using a single pulse of pressure requires a substantially longer pressurizing time than using multiple pulses. Suitable conditions for commercial sterilization using a single pressure pulse are believed to be pressurizing at an initial temperature of at least about 60° or preferably 90° C. or higher for more than 5 or preferably 10 minutes using a pressure of at least about 100,000 psi or higher to produce a final temperature of about 115° C. to greater than 121° C.

Another important aspect of the invention is limiting the exposure of the potatoes to an elevated temperature between the first heating Step 16 and the high-pressure sterilization in Step 26. Suitably, the total time between these steps is preferably less than 75 minutes, more preferably less than 65 minutes, 55 minutes, and 45 minutes, and most preferably 30 minutes to 10 minutes or less.

After pressurizing in Step 26, the pressure is released in Step 28 and thereby cooled to lower the temperature to approximately the same level as the initial pressurizing temperature. At this point, the packaged mashed potatoes are commercially sterile.

In Step 30, the packaged mashed potatoes are commercially sterile and so “shelf-stable,” i.e., they can be stored on the shelf at ambient temperatures. Prior to storage, the product can be cooled, such as by placing the packages in cold water, e.g., less that 10° C., to achieve an ambient temperature, e.g., about 25° C. The packages may then be surface-dried and placed in containers for storage in Step 30 and shipment at such ambient temperatures.

In Step 32, the end user may heat the mashed potatoes in the package as by placing the package in hot water. Then the package may be opened and the mashed potatoes placed on a serving dish, whipped, as with a fork, and served. Alternatively, the packages can be opened and placed on a steam table pan or microwaved to heat them to the desired end temperature, and thereafter prepared for eating as by whipping with a fork.

As set forth above, the packaged mashed potatoes (or other vegetables) processed according to the invention are preferably commercially sterile as that term is used in the '115 patent. The '115 patent is focused on sterility and does not specify the time of cooking or re-heating, hold time before pressurization, and cycle time in the vessel. These times are very critical for potatoes and other vegetables to provide a fresh-like flavor/texture profile.

In an alternative according to the invention, after mashing, the potatoes are cooled and, optionally, stored followed by heating to the initial pressurizing temperature of at least about 60° C. In this embodiment, the cooled mashed potato is heated to an initial pressurizing temperature at a time less than about 120 minutes and more preferably less than 90 minutes, 60 minutes, 30 minutes, 10 minutes, or less. This process provides fresh-like shelf-stable mashed potatoes but is not as cost efficient as the non-cool process.

The above process can also be used for making other mashed vegetables such as beans. For dried beans the preparation includes a rehydration soak step after which the UHP sterilization process is similar to mashed potatoes.

The present invention also encompasses use of UHP sterilization to produce shelf-stable vegetable products in a form other than mashed. Such processes will be described below: (1) for potato fries and pieces from whole potatoes or precut potatoes, and (2) for whole potatoes for bakers, mashed, potato salad, and the like.

2. Whole Potatoes, Fries and Pieces

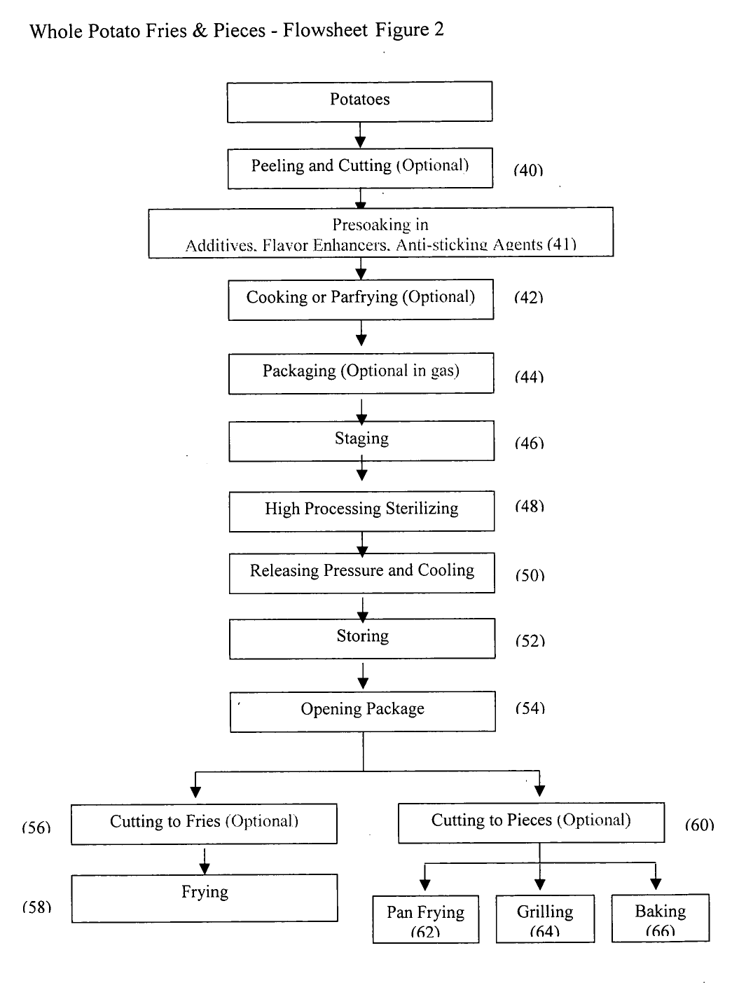

In one process, illustrated in FIG. 2 in a step not shown, the potatoes are first sorted to the desired size, e.g., graded at greater than 2 inches and less than 2.75 inches in diameter. Alternatively, the potatoes may be cut into a desired size for the desired end product.

In Step 40, the potatoes are peeled and may remain whole. The potatoes may also be optionally cut into fry strips (˜3/16 inch to ½ inch or larger square cuts) as well as wedges, shreds, chunks, slices,. and the like. The potatoes may also be dried prior to pressurization to reduce the moisture content up to 25% or more to enhance separation. The potatoes may also be subjected to a hot oil par-fry to provide the necessary temperature for the high pressure sterilization process.

In Step 41, the potatoes optionally are presoaked in, or coated with, one or more additives including flavor enhancers, usually for infusion into potatoes or other vegetables. For example, the potatoes may be soaked in or coated with one or more of the following: (1) a solution of a firming agent such as calcium chloride, (2) a browning control agent such as glucose or dextrose, (3) an enzyme control agent such as sodium acid pyrophosphate, (4) flavoring ingredients (e.g., roasted potato, salt, garlic, onion, sour cream, barbeque, cheese, or bacon), (5) surface crispers and anti-stick agents (e.g., batter, starch, emulsifier, cellulose, and /or gum coating, and the like) with or without a par-fry step, (6) an alginate gel in contact with a multivalent metal ion such as calcium in CaCl₂ to cross-link the alginate to form a moisture barrier coating, (7) nutrients such as vitamins, minerals, and other health-inducing agents (lycopene, etc.) in solution for infusion, and (8) color fixatives for green vegetables (e.g., zinc, carbon dioxide). High pressure greatly assists driving additives deep into the vegetable product.

In Step 42, the potatoes are only partially cooked to a uniform internal temperature of at least about 60° C. or preferably at least 80° C., but no greater than the temperature of 85° to 95° C. Although any of a number of heating techniques may be used for this Step 42, it is preferable to rapidly heat to the desired internal temperature using the above suitable rapid heating techniques including the use of an energy source such as a microwave or other radio frequency sources. Preferably, the time to heat to the partial cooking temperature is less than about 8 minutes, and more preferably less than 6 minutes, and most preferably 2 minutes or less for whole potatoes or for precut potatoes. By rapidly heating the whole potato or pieces to the desired temperature for UHP sterilization treatment, the starch of the potato is not totally gelatinized resulting in a high-pressure-processed sterile whole potato with texture attributes similar to uncooked potatoes. With this uncooked characteristic the potatoes may be cut with commercially available equipment into fries or strips or other pieces. Gelatinization of the potato starch is characterized by the collapse or disruption of molecular order within the starch granule with concomitant and irreversible changes in properties such as granular swelling, crystallite melting, loss of birefringence, viscosity development, and starch stabilization as defined in Atwell et al., Cer. Fds. World 33(1988) 306. The melting of the crystallites in the starch as the temperature is raised is characterized by heat uptake at the starch melting point. This effect was first demonstrated by Stevens and Elton, Starch 23 (1971) 8 using differential scanning calorimetry (DSC) technology. Using DSC methods the percent of gelatinized starch based on heat uptake at various times after achieving a desired temperature may be obtained (Lund, CRC Critical Reviews in Food Science and Nutrition, 20 (1984), 249).

For end product(s) such as baked potatoes, hash browns (shreds), precut or end user cut French fries, or other uses in which firmer potatoes are desired, it is preferred that the potato be only partially cooked. One measure of the preferred partial cook is that the degree of starch gelatinization is preferably less than 80%, more preferably less than 70%, even more preferably less than 60%, and most preferably less than 50%. Percent or degree of gelatinized starch may be determined by the method described above.

In Step 44, the cooked potatoes are then packaged in bags of UHP-acceptable material (described above). The potatoes may be packaged in commercial quantities. Thus, each bag may contain one potato or part of a potato to as much as 10 pounds, 20 pounds, 30 pounds, 40 pounds, 50 pounds, or more in a single bag. The packaging is preferably maintained at an elevated temperature no less than about 10° C. below the temperature of thermalizing in Step 42. The products may be packaged in a gas as necessary to provide piece separation and integrity after the sterilization process. One way to accomplish such packaging at elevated temperatures is the same as with FIG. 1, namely, to package in a steam-blanketed chamber at a temperature in excess of 60° C., or preferably 85° C. to as high as 95° C. or more in an anaerobic condition such as a vacuum or an inert gas.

In Step 46, the packaged potatoes are staged in a manner similar to that described above with respect to staging 24 in FIG. 1. As specifically comparable in mode of staging is to place the packaged potato in plastic vessels filled with a hot water bath at a temperature in excess of 60° C., preferably 90° C., as high as 95° C. for a minimum amount of time to accomplish the transfer. A suitable time is less than 10 minutes or preferably less than 5 minutes or 3 minutes, and most preferably less than 2 minutes.

During the time between cooking Step 42 and high-pressure processing Step 48, which immediately precedes high-pressure sterilizing, it is preferable that the time of exposure to a temperature in excess of about 60° C. is no greater than 60 minutes, and most preferably less than 20 minutes, 15 minutes, 10 minutes, or at best less than 3 minutes.

In Step 48, the potatoes are subject to high-pressure sterilization. Step 48 may be accomplished by multiple pressure pulses or a single pressure pulse using the parameters described above with respect to Step 26 of FIG. 1.

In Step 50, the pressure is released and the product is cooled, suitably in a manner such as set forth with respect to Step 28 of FIG. 1.

In Step 52, the commercially sterile and so shelf-stable product is stored at ambient temperatures or refrigerated. Then, when the end user desires to use the product, the package is opened in Step 54 and may be used to make a number of end products.

Referring to Step 56, the product may be cut to the desired size for French fried potatoes (e.g., 0.25 inch in thickness.) Thereafter the product may be fried using conventional frying techniques for making French fries from fresh potatoes, suitably deep frying for about 70 seconds at about 175° C.

No par-frying is necessary and so the oil content of the finished French fries is significantly less than ones made from current frozen products resulting in fewer calories per serving. Thus, conventional 0.25 inch French fries typically have an oil content of about 17% while the French fries of the present invention may have an oil content less than 10%, preferably less than 9% and more preferably less than 8%.

Another advantage of the present high pressure sterilization process is that the amount of reducing sugar present in the potato can be increased by 50% or more, relative to the levels normally preferred of 2% (wt.) reducing sugar or less. This significantly reduces the cost of the potato raw material.

Another characteristic of the process is that the potato is firmed by the pressurizing Step 48 in comparison to a conventional potato. This has the desirable characteristic of retrograding the amylose starch component for a French fried potato.

In Step 60, an alternative to cutting to fries in Step 56, potatoes in the package opened in Step 54 may be cut to piece size (say from 0.25 inch to 1 inch or larger). Such pieces have the following desirable properties of having essentially fresh-like flavor and texture characteristics but because of the retrogradation characteristics the cut pieces may be prepped in a quicker time than raw potatoes of the same piece size.

Suitably, the pieces may be pan fried as in Step 62, grilled as in Step 64, or baked in Step 66 by conventional techniques, which are well known in potato processing. For a baked product, the potato may be peeled or unpeeled, and flavorings (e.g., butter, sour cream, bacon, chives, and the like) may be added (e.g., by enrobing around the potato) prior to packaging. Then the potato may be subjected to the high-pressure sterilization of Step 48, which causes the flavorings to penetrate deeply into the potato.

3. Whole Potatoes

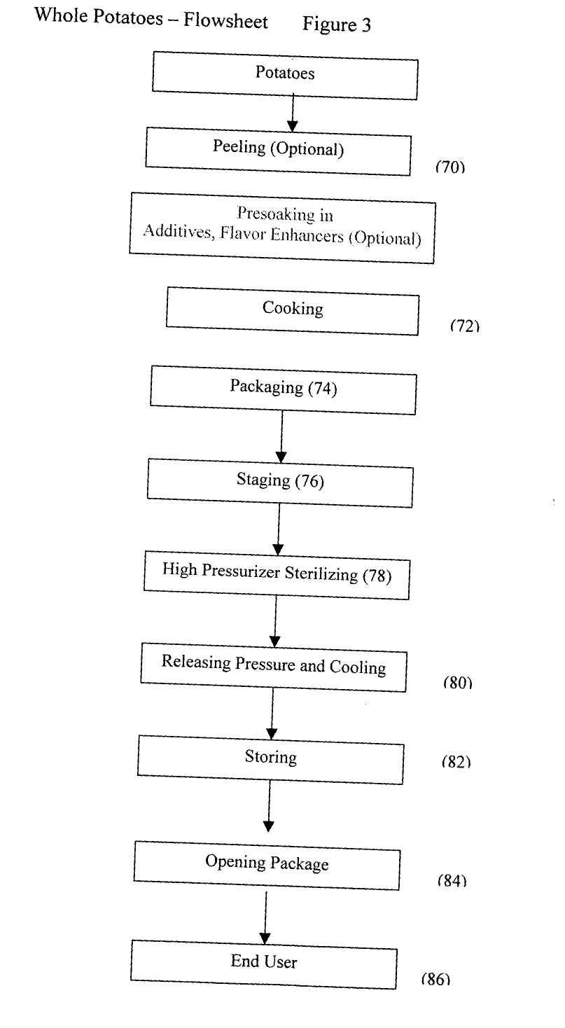

Referring to FIG. 3, another non-mashed potato process is illustrated for producing a shelf-stable product suitable for use as whole potato for baking, for mashing and for use in potato salad and the like. FIG. 3 is a schematic flow of the process, which is similar in many respects to the process of FIG. 2.

In Step 70, the potatoes are optionally peeled and sorted. Suitable size of the potato is on the order of 02.5 inches in diameter or less.

In Step 72, the potatoes may be cooked at a slower rate than that of FIG. 2 to achieve a substantially higher degree of cooking than the potatoes of FIG. 2. As set forth above, one measure of the degree of cooking is the degree of gelatinization as determined by the technique described above. Preferably, the degree of gelatinization is at least 90%, preferably 95%, and most preferably to 98% or 99%. Conventional steam or water cooking may be used. Suitably, heating the potato to the desired temperature is from about 80° C. to 95° C. This temperature may be the same as those set forth with respect to the at least partial cooking in FIG. 1. Preferably, the time to heat to this temperature is less than about 90 minutes, and more preferably less than 65 minutes, 50 minutes, 30 minutes, 15 minutes, or less.

In Step 74, the potatoes are packaged in suitable UHP material bags under conditions set forth with respect to Step 22 in FIG. 1.

In Step 76, the packages are staged suitably under the conditions set forth with respect to Step 24 of FIG. 1.

In Step 78, potatoes are subjected to high-pressure sterilizing suitably under the conditions set forth with respect to Step 26 of FIG. 1.

The total processing time from the raw potato to sterilization is comparable to that for mashed potatoes. Suitably, the time will be less than 120 minutes and more preferably less than 85 minutes, even more preferably less than 60 minutes, and most preferably less than 30 minutes, 20 minutes, and the like. Similarly, the total processing time from cooking to sterilization is comparable to that of the mashed product in FIG. 1. Such time can be less than 40 minutes, 30 minutes, 20 minutes, 10 minutes or less.

In Step 80, the pressure is released and the product cooled, suitably under the same conditions as Step 28 of FIG. 1.

In Step 82, the product may then be placed in containers for storage. In the packages, the potatoes preferably are commercially sterile and are stable under refrigeration as well.

In Step 84, the package may be opened by the consumer for a variety of end uses in steps designated in 86. One such end use is to heat the potato to the desired temperature for baking or to mash or use in a conventional recipe. Alternatively, the potato may be cut in pieces or chunks for potato salad recipes or casseroles or skillet fried.

Because the shelf-stable whole potato has been gelatinized, it may be cooked for serving (i.e., with a microwave) in about one third the time of raw potatoes while having the characteristic flavor and texture of the potato cooked from raw. This lends itself to utilization in quick-service establishments.

In order to more clearly illustrate the present invention, examples of its practice are hereby given.

FIG. 1 Example

Idaho Russet Burbank potatoes were peeled and cut into 0.75-inch to 1-inch longitudinal slabs. The pieces were steam cooked for 28 minutes to an interior temperature exceeding 87.8° C. after which they were placed hot in a Hobart mixer bowl. Flavor additives consisting of milk, butter, and salt heated to ˜87.8° C. were added to the potatoes in the mixer bowl. The mixture was mixed on slow speed for 30 seconds, the walls scraped down, then mixed for 30 seconds at medium speed, then mixed for 30 seconds at high speed. The mashed potatoes spread to ˜1 inch thickness in a metal pan was placed in a 4.4° C. cooler room overnight to chill. The chilled mashed potatoes were packaged using a Multi-Vac sealer in 300 gram pouches (0.75 mils nylon layered with a high-temperature adhesive to 2.25 mils of polypropylene) under 30 millibars pressure. The sealed pouches were shipped to the location of the ultra-high-pressure equipment in coolers at less than 4.4° C. The pouches were exposed to 99.4° C. water for 9 minutes at the ultra-high-pressure facility to raise the center temperature to >85° C., after which the pouches were transported in >93.3° C. water to the high-pressure machine. The walls of the high-pressure machine and water within the machine were adjusted to an 85° C. initial temperature. The 300-gram potato pouches were placed under water in the UHP machine, the vessel door was closed, and the high pressure commenced. The system attained 100,000 psi in 92 seconds with a corresponding adiabatic temperature increase of ˜35° C. resulting in ˜120° C. water temperature at peak pressure. The system held the pressure for 1 minute, then depressurized in ˜5 seconds, after which the second high-pressure pulse and depressurization identical to the first commenced. The total time that the mashed potato pouches were in the machine at >85° C. was ˜5 minutes 20 seconds, after which the mashed potato pouches were cooled in ice water. To serve, the chilled mashed potato pouches were placed in 87.8° C. water for 4 minutes, the bag was cut open, the mashed potatoes were removed, and fluffed with a fork. Blind organoleptic analyses by trained personnel skilled in tasting mashed potatoes revealed no preference between UHP-treated mashed potatoes and untreated control mashes potato pouches. Ten random samples from a population of 100 were left at room temperature for 35 days and then analyzed by a reputable microbiological lab and found to meet FDA commercial sterility requirements.

FIG. 2 Example

Idaho Russet Burbank potatoes of 2.25 inches to 2.75 inches in diameter were peeled and trimmed to 0.5 pound whole potato pieces. The whole potatoes were soaked at ambient temperature in a 4.8 weight % solution of calcium chloride and rinsed. The whole potatoes were packaged using a Multi-Vac sealer in pouches (0.75 mils nylon layered with a high-temperature adhesive to 2.25 mils of polypropylene) under 30 millibars pressure. The sealed pouches were shipped to the location of the ultra-high-pressure equipment in coolers at less than 4.4° C. The pouches were placed in a model # MN-S543 Panasonic inverter 1300 watt microwave as follows: 2 bags were placed on the turntable at 10° C. and microwaved at full power for 100 seconds, the pouches were turned over, microwaved at full power for 35 seconds (turned over half way), there was a 1-minute pause and the pouch turned over, the pouch was microwaved at full power for 15 seconds, the pouch was turned over, there was a 1-minute pause, the pouch was turned over and microwaved at full power for 25 seconds, for a total time in the microwave of 4 minutes 55 seconds to heat the center of the potato to >85° C. The potatoes were placed in >93.3° C. water for 2 minutes to insure the entire potato was >85° C., after which the pouches were transported in >93.3° C. water to the high-pressure machine. The walls of the high-pressure machine and water within the machine were adjusted to 85° C. initial temperature. The 225-gram whole potato pouches were placed under water in the UHP machine, the vessel door was closed, and the high pressure commenced. The system attained 100,000 psi in 92 seconds with a corresponding adiabatic temperature increase of ˜35° C. resulting in ˜120° C. water temperature at peak pressure. The system held the pressure for 1 minute, then depressurized in ˜5 seconds, after which the second high-pressure pulse and depressurization identical to the first commenced. The total time that the whole potatoes were in the machine at >85° C. was˜5 minutes 20 seconds, after which the mashed potato pouches were cooled in ice water. The total time the potatoes were at a temperature environment above 10° C. was 12.5 minutes. The chilled whole potatoes were cut using a conventional 0.25-inch fry strip cutter into strips and deep fat fried 60 seconds at 182.2° C. Trained personnel skilled in tasting fried potatoes revealed that these had a fresh-like taste and texture. The % oil level was analyzed at 7.8% while a commercial fast food product made from frozen, parfried potatoes analyzed at 17% oil.

FIG. 3 Example

Idaho Russet Burbank potatoes sized to 0.5 pounds each with skin on were washed and placed in pouches (0.75 mils nylon layered with a high-temperature adhesive to 2.25 mils of polypropylene) with the pouches left open on the turn table of a model # MN-S543 Panasonic inverter 1300 watt microwave as follows: Place 4 potatoes at ˜10° C. in the microwave and microwave on full power for 6 minutes to achieve a core temperature >85° C. Quickly remove potatoes from the microwave and heat seal each pouch using the stream generated to remove air from the pouch. Place potatoes in >93.3° C. water for 2 minutes to insure the entire potato is >85° C. after which the pouches were transported in >93.3° C. water to the high-pressure machine. The walls of the high-pressure machine and water within the machine were adjusted to 85° C. initial temperature. The 0.5-pound whole potato pouches were placed under water in the UHP machine, the vessel door was closed, and the high pressure commenced. The system attained 100,000 psi in 92 seconds with a corresponding adiabatic temperature increase of ˜35° C. resulting in ˜120° C. water temperature at peak pressure. The system held the pressure for 1 minute, then depressurized in ˜5 seconds, after which the second high-pressure pulse and depressurization identical to the first commenced. The total time that the whole potatoes were in the machine at >85° C. was ˜5 minutes 20 seconds, after which the mashed potato pouches were cooled in ice water. The total time the potatoes were at a temperature environment above 10° C. was 17.5 minutes. The chilled ˜4.4° C. whole potato with the pouch punctured to remove steam was microwaved for 90 seconds in a 1300 watt microwave. The pouch was removed and the potato was served. Trained personnel skilled in tasting baked potatoes revealed that this product had a fresh-like taste and texture even though the preparation time was only 90 seconds.

Potato Piece Example

Equal quantities of small red potatoes and small white potatoes (˜1 inch to 1.75 inch in diameter), purchased at a local super market, were washed with skins on, quartered into wedges, and rinsed. The potatoes along with appropriate amounts of diced fresh onion and garlic were dried two minutes using 71.1° C. air, then stirred into approximately 0.5 inch of Crisco shortening in a preheated pan for 20 seconds. Care was given to insure that all the wedges and seasoning vegetables were coated with the shortening. Appropriate amounts of salt and pepper were added during the stirring step. The product was then vacuum packaged in pouches (0.75 mils nylon layered with a high-temperature adhesive to 2.25 mils of polypropylene) at 100 grams per pouch using a Multi-Vac sealer set at 30 millibar pressure. To insure package integrity the sealed bag was vacuum packaged in a second pouch. The sealed pouches were shipped to the location of the ultra-high-pressure equipment in coolers at less than 4.4° C. The pouches were placed in a model #MN-S543 Panasonic inverter 1300 watt microwave as follows: 9 bags at 10° C. were placed on the turntable and microwaved at full power for 210 seconds, turning the pouches over at 120 seconds, pausing 1 minute, turning the pouches over, and microwaving at full power for 1 minute, pausing 1 minute, turning over the pouches, microwaving at full power for 120 seconds (turning over every 30 seconds), for a total time in the microwave of 8 minutes 30 seconds to heat the center of the potato wedges to >85° C. The potatoes wedges were quickly removed from the microwave and placed in >93.3° C. water for 2 minutes to insure the entire potato was >85° C., after which the pouches were transported in >93.3° C. water to the high-pressure machine. The walls of the high-pressure machine and water within the machine were adjusted to a 85° C. initial temperature. The nine 100-gram potato wedge pouches were placed under water in the UHP machine, the vessel door was closed, and the high pressure commenced. The system attained 100,000 psi in 92 seconds with a corresponding adiabatic temperature increase of ˜35° C. resulting in ˜120° C. water temperature at peak pressure. The system held the pressure for 1 minute, then depressurized in ˜5 seconds, after which the second high-pressure pulse and depressurization identical to the first commenced. The total time that the whole potatoes were in the machine at >85° C. was ˜5 minutes 20 seconds, after which the wedge pouches were cooled in ice water. The total time the potatoes were at a temperature environment above 10° C. was 16 minutes. The chilled potato wedges were thermalized in 87.8° C. water for 2 minutes and the pouch was cut open. The thermalized potato wedges and seasoned vegetables poured freely from the pouch onto a plate. Trained personnel skilled in tasting baked potato wedge side dishes revealed that these had a fresh-like taste and texture even though the preparation time was only 2 minutes.

Bean Example

Dried, cleaned pinto beans were simmered 20 minutes, drained, and placed in cold water with 0.1% calcium chloride added, then simmered for 60 minutes, drained and vacuum packaged in pouches (0.75 mils nylon layered with a high-temperature adhesive to 2.25 mils of polypropylene) at 0.66 pounds per pouch cooling the contents to ˜25° C. The vacuum pouches were placed in boiling water for 10 minutes to heat to 90° C. The pouches were then placed in >95° C. water for transporting to UHP machine. The walls of the high-pressure machine and water within the machine were adjusted to 90° C. initial temperature. The 0.66-pound bean pouches were placed under water in the UHP machine, the vessel door was closed, and the high pressure commenced. The system attained 100,000 psi in 92 seconds with a corresponding adiabatic temperature increase of ˜335° C. resulting in ˜125° C. water temperature at peak pressure. The system held the pressure for 30 seconds, then depressurized in ˜5 seconds, after which the second high-pressure pulse and depressurization identical to the first commenced. The total time that the whole potatoes were in the machine at >90° C. was ˜4 minutes 40 seconds, after which the bean pouches were cooled in ice water. The total time the cooked beans were at a temperature environment above 25° C. was 17 minutes. The chilled beans had the pouch punctured to remove steam and were microwaved for 150 seconds in a 1300 watt microwave, after which the pouch was removed and the beans were served. Trained personnel skilled in tasting beans revealed that these had a fresh-like taste and texture even though the preparation time was only 02.5 minutes.

### EXAMPLE 6

This example illustrates the process for non-par-fried potato strips. Idaho Russet Burbank potatoes sized at 175-225 grams each were peeled and cut into 0.25-inch potato strips. The strips were soaked for 60 minutes in 62.8° C. 0.5% (weight) solution of calcium chloride, creating a firming effect on strips caused by calcium pectate formation. After water rinsing, 100 gram lots of the strips were placed mono layer in a 1300 watt microwave oven and microwaved at full power for 40 seconds to heat the center to >85° C. The strips were quickly removed from the microwave oven and placed in pouches (0.75 mils nylon layered with a high-temperature adhesive to 2.25 mils of polypropylene) and heat sealed (it is very important that that a small amount of gas remain in the package to allow the fries to separate after the high-pressure sterilization treatment). The pouches were then placed in greater than 93.3° C. water for at least 2 minutes to insure the center of the strips is greater than 85° C., and transported to the ultra-high-pressure machine. The walls of the high-pressure machine and water within the machine were. adjusted to 85° C. initial temperature. The 100-gram pouches were placed under water in the UHP machine, the vessel door was closed, and the high pressure commenced. The system attained 100,000 psi in 92 seconds with a corresponding adiabatic temperature increase of about 35° C., resulting in about 120° C. water temperature at peak pressure. The system held the pressure for 1 minute, then depressurized in about 5 seconds, after which the second high-pressure pulse and depressurization identical to the first commenced. The total time that the whole potatoes were in the machine at greater than 85° C. was about 5 minutes 20 seconds, after which the mashed potato pouches were cooled in ice water. The total time the potatoes were at a temperature environment above 62.8° C. was 8.5 minutes. The bag of the chilled 0.25-inch fries was cut open, and the fries were poured into a fry basket and deep fat fried 60 seconds at 182.2° C., which contrasts with the more than 2.5 minutes needed for commercial, frozen par-fried 0.25-inch potato fries. Trained personnel skilled in tasting fried potatoes revealed that these had a fresh-like taste and texture. The oil level was analyzed at 8%, while a commercial 0.25-inch fast food fry produced from frozen, par-fried potatoes analyzed at 17% oil.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for making a shelf-stable product comprising a comminuted vegetable, said method comprising the steps of:
(a) at least partially cooking a vegetable having a pH of at least 4.5;
(b) comminuting the vegetable of step (a);
(c) packaging the comminuted vegetable of step (b) in a sealed container;
(d) optionally mixing flavoring ingredients with the comminuted vegetable prior to step (c);
(e) sterilizing said packaged vegetable by pressurizing comprising subjecting said packaged comminuted vegetable in at least one stage to a first pressure of at least about 50,000 psi at a first temperature above ambient temperature to heat the comminuted vegetable to a temperature in excess of about 90° C. to render it shelf-stable, wherein said vegetable is not subjected to an elevated temperature for a time greater than about 120 minutes after comminuting in step (b) and prior to sterilization in step (e); and
(f) releasing said pressure.

2. The method of claim 1 in which said sterilized vegetable of step (f) when reheated and served has a flavor substantially the same as said comminuted vegetable in step (b).

3. The method of claim 1 in which said comminuted vegetable is not subjected to said elevated temperature for a time greater than about 25 minutes.

4. The method of claim 1 in which said vegetable is not subjected to said elevated temperature for a time greater than about 15 minutes.

5. The method of claim 1 in which said elevated temperature is at least about 75° C.

6. The method of claim 1 in which prior to said cooking in step (a), said vegetable is precooked and cooled.

7. The method of claim 1 in which said vegetable is not cooled more than about 30° C. between mashing in step (b) and sterilizing in step (e).

8. The method of claim 1 in which said first temperature is greater than about 60° C.

9. The method of claim 1 in which said vegetable is selected from the group consisting of: potatoes, bean, avocados, broccoli, squash, peas, carrots, radishes, rutabaga, asparagus, beets, string beans, other legumes, grains, such as corn, wheat and rice, sweet potatoes, yams, cauliflower, cabbage, kohlrabi, okra, spinach, garlic, onions, peppers, tomatoes, parsley, parsnips, turnips, cucumbers, plant sprouts, celery, bok choy, collards, Brussels sprouts, egg plants, squash, pumpkins, fennel, kale, pomegranate, leeks, lettuce, mushrooms, olives, rhubarb, chives, and coconut.

10. The method of claim 1 in which said vegetable is potatoes or beans.

11. The method of claim 1 in which said vegetable is potatoes.

12. The method of claim 1 in which said pressurizing further comprises the steps of releasing said first pressure and subjecting said packaged vegetable in a second stage to a second pressure in excess of 30,000 psi at a second temperature above ambient temperature, said second stage occurring either before or after said first stage, and wherein pressure is released between said first and second stages.

13. The method of claim 1 further comprising the steps of:
(g) after step (b) and prior to step (e), cooling said mashed vegetable; and
(h) after step (g), heating said cooled mashed vegetable to said initial pressurizing temperature in a time less than about 40 minutes.

14. The method of claim 13 in which said heating in step (h) is for less than about 15 minutes.

15. A method for making a shelf-stable product comprising a partially cooked uncomminuted vegetable, said method comprising the steps of:
(a) packaging an uncomminuted partially cooked vegetable at a temperature in excess of about 60° C. in a sealed container;
(b) sterilizing said packaged partially cooked uncomminuted vegetable by pressurizing comprising subjecting said packaged uncomminuted vegetable in at least one stage to a first pressure of at least 50,000 psi at a first temperature above ambient temperature to heat the uncomminuted vegetable to a temperature in excess of about 90° C. to render it shelf-stable; and
(c) releasing said pressure.

16. The method of claim 15 in which said sterilized uncomminuted vegetable after step (c) when reheated and served has a flavor substantially the same as said partially cooked vegetable of step (a).

17. The method of claim 15 in which said vegetable is pressurized within about 15 minutes of packaging.

18. The method of claim 15 in which said uncomminuted vegetable is heated to said packaging temperature in less than about 65 minutes.

19. The method of claim 15 in which said packaged uncomminuted vegetable at a temperature in excess of 60° C. is placed in a chamber for pressurizing in step (b).

20. The method of claim 15 wherein said packaged vegetable is pressurized within about 120 minutes of packaging.

21. The method of claim 15 in which said uncomminuted packaged vegetable is not cooled more than about 30° C. between packaging in step (a) and sterilizing in step (b).

22. The method of claim 15 in which said first temperature is greater than about 70° C.

23. The method of claim 15 in which said vegetable is selected from the group consisting of: potatoes, beans, avocados, broccoli, squash, peas, carrots, radishes, rutabaga, asparagus, beets, string beans, other legumes, grains such as corn, wheat and rice, sweet potatoes, yams, cauliflower, cabbage, kohlrabi, okra, spinach, garlic, onions, peppers, tomatoes, parsley, parsnips, turnips, cucumbers, plant sprouts, celery, bok choy, collards, Brussels sprouts, egg plants, squash, pumpkins, fennel, kale, pomegranate, leeks, lettuce, mushrooms, olives, rhubarb, chives, and coconuts.

24. The method of claim 15 in which said vegetable is potatoes or beans.

25. The method of claim 15 in which said vegetable is potatoes.

26. The method of claim 15 in which said pressurizing further comprises the steps of releasing said first pressure and subjecting said packaged vegetable in a second stage to a second pressure in excess of 30,000 psi at a second temperature above ambient temperature, said second stage occurring either before or after said first stage, and wherein pressure is released between said first and second stages.

27. The method of claim 25 in which said potato is at least partially peeled prior to packaging.

28. The method of claim 15 in which said vegetable is subject to a temperature in excess of 70° C. for less than about 60 minutes prior to pressurizing.

29. The method of claim 25 in which, after releasing said pressure, said potato is cut into pieces and fried.

30. The method of claim 25 in which, after releasing said pressure, said potato is grilled or baked.

31. The method of claim 25 in which, after pressurizing, said potato is cooked.

32. The method of claim 25 in which said partially cooked potato is whole or in pieces.

33. The method of claim 32 or 15 in which said partially cooked potato is characterized by having less than 80% of the starch gelatinized.

34. A shelf-stable potato which, when precut or cut into a size suitable for making French fries, is friable to French fries in less than about 40% of the frying time, under the same frying conditions, of frozen potatoes of the same size.

35. A shelf-stable potato which, when precut or cut into a size suitable for making French fries, is friable to a French fry having an oil content less than about 50% of the oil content of fries produced at the same frying temperature from frozen potatoes of the same size.

36. The method of claim 33 wherein the partially cooked potato is characterized by a degree of gelatinization less than 70%.

37. The method of claim 33 wherein the partially cooked potato is characterized by a degree of gelatinization less than 60%.

38. The method of claim 33 wherein the partially cooked potato is characterized by a degree of gelatinization less than 50%.

39. A method for making a shelf-stable potato product comprising a partially cooked whole or potato piece, the method comprising the steps of:
(a) packaging a partially cooked whole potato or potato piece, said whole or potato piece having been cooked but the degree of gelatinization being less than 80%;
(b) sterilizing said packaged potato by pressurizing comprising subjecting said packaged potato in at least one stage to a first pressure of less than 50,000 psi at a first temperature above ambient temperature to heat the potato to a temperature in excess of about 90° C. to render it shelf stable; and
(c) releasing said pressure.

40. The method of claim 39 wherein the partially cooked potato is characterized by a degree of gelatinization less than 70%.

41. The method of claim 39 wherein the partially cooked potato is characterized by a degree of gelatinization less than 60%.

42. The method of claim 39 wherein the partially cooked potato is characterized by a degree of gelatinization less than 50%.
